(19) United States
(12) Patent Application Publication
(10) Pub. No.: US 2026/0051689 A1
(43) Pub. Date: Feb. 19, 2026

(54) BOARD-TO-BOARD PLUG CONNECTOR

(71) Applicant: ADVANCED-CONNECTEK INC., New Taipei City (TW)

(72) Inventors: Chao-Tsung Lin, New Taipei City (TW); Ta-Teh Meng, New Taipei City (TW); Mei Shi, New Taipei City (TW); Ya-Ping Liang, New Taipei City (TW); Ping Shi, New Taipei City (TW)

(21) Appl. No.: 19/299,715

(22) Filed: Aug. 14, 2025

Related U.S. Application Data
(60) Provisional application No. 63/682,814, filed on Aug. 14, 2024.

(51) Int. Cl. H01R 13/50; H01R 12/70; H01R 12/71

(52) U.S. Cl. CPC H01R 13/50; H01R 12/7082; H01R 12/7088; H01R 12/712

(57) ABSTRACT

A board-to-board plug connector includes a base portion, a plug member, and a plurality of plug signal terminals. Each of the plug signal terminals includes a fixed section, a flat contact section, and an extension section. Two ends of the fixed section respectively extend toward the flat contact section and the extension section. The base portion includes two inner walls, a tongue portion, a recessed portion, and a plurality of signal terminal grooves. The tongue portion is between the two inner walls, the signal terminal grooves are at two sides of the tongue portion and at the two inner walls, and the recessed portion is enclosed by one end of the tongue portion and the two inner walls. The plug member is arranged in the recessed portion, and the plug member contacts the extension sections of the plug signal terminals.

### CROSS-REFERENCE TO RELATED APPLICATION

This application claims the benefit of U.S. provisional application Ser. No. 63/682,814, filed on Aug. 14, 2024, the entire contents of which are hereby incorporated by reference.

### FIELD OF THE INVENTION

The instant disclosure relates to a board-to-board plug connector.

### BACKGROUND

Board-to-board (also abbreviated as BTB) connectors are provided for achieving electrical connection between respective mechanisms and apparatuses through respective circuit boards, thereby allowing transmission and conduction of the electrical signals and the power supply.

In general, to achieve different autopilot functions, advanced driver assistance (abbreviated as ADAS) may adopt floating-type BTB connectors to deal with the position offset caused by external forces. However, connectors known to the inventor have several issues. For example, for manufacturing connectors with height exceeding 7 mm, in order to prevent the molded product with insufficient structural strength which thus results in molding failure, additional processes are applied in mold manufacturing for the connectors, thereby causing the entire molding manufacturing process to be too complicated.

### SUMMARY OF THE INVENTION

In view of these, in one embodiment, a board-to-board plug connector comprising a base portion, a plug member, and a plurality of plug signal terminals is provided. The base portion comprises two inner walls, a tongue portion, a recessed portion, and a plurality of signal terminal grooves. The tongue portion is between the two inner walls, the signal terminal grooves are at two sides of the tongue portion and at the two inner walls, and the recessed portion is enclosed by one end of the tongue portion and the two inner walls. Each of the plug signal terminals comprises a fixed section, a flat contact section, and an extension section. The fixed section is in the signal terminal groove, the flat contact section extends from one of two ends of the fixed section and is exposed from one of the two sides of the tongue portion, and the extension section extends from the other end of the fixed section and is exposed from one of two sides of the recessed portion. The plug member is arranged in the recessed portion, and the plug member contacts the extension sections of the plug signal terminals.

In some embodiments, each of the signal terminal grooves comprises an exposed section, a channel section, and a communication section. Two ends of the channel section are respectively in communication with the exposed section and the communication section, and the flat contact section is interference-fitted with the exposed section.

In some embodiments, the exposed section comprises a tapered portion and an accommodation portion, a distance between two side walls of the tapered portion is less than a distance between two side walls of the accommodation portion, and a free end of the flat contact section is interference-fitted with the two side walls of the tapered portion.

In some embodiments, the plug member comprises a plurality of ribs, and the ribs are interference-fitted with the two inner walls of the base portion.

In some embodiments, the plug member further comprises an end portion, a first contact section, and a second contact section, one end of the first contact section extends toward the second contact section and the end portion, and the ribs are at the end portion.

In some embodiments, the board-to-board plug connector further comprising a plurality of plug power terminals. Two sides of the first contact section contact the extension section of the plug signal terminal, and the second contact section of the plug member is adapted to contact the plurality of plug power terminals.

In some embodiments, a thickness of the second contact section is less than a thickness of the first contact section, and the thickness of the first contact section is less than a thickness of the end portion.

In some embodiments, a ratio between a height of the plug member and a height of the base portion is 1:3.

In some embodiments, a ratio between a height of the plug member and a height of the tongue portion is 1:2.

In some embodiments, a thickness of the plug member is greater than a thickness of the tongue portion.

According to one or some embodiments, the plug member can be provided for limiting the movements of the terminals. Moreover, the plug member can also reduce the exposure of the terminals to air to maintain the high-frequency signal transmission performance. Furthermore, through the configuration of the recessed portion of the plug connector, the difficulty in the manufacturing of the base portion can be reduced.

### BRIEF DESCRIPTION OF THE DRAWINGS

The instant disclosure will become more fully understood from the detailed description given herein below for illustration only, and thus not limitative of the instant disclosure, wherein:

FIG. 1A illustrates an exploded view of a floating-type board-to-board connector assembly according to some embodiments of the instant disclosure;

FIG. 1B illustrates an enlarged partial view of the region 1B shown in FIG. 1A;

FIG. 2 illustrates an exploded view of a plug connector according to some embodiments of the instant disclosure;

FIG. 3A illustrates a perspective view of a plug signal terminal according to some embodiments of the instant disclosure;

FIG. 3B illustrates a perspective view of a plug power terminal according to some embodiments of the instant disclosure;

FIG. 4 illustrates a cross-sectional view along line 4-4 shown in FIG. 1A;

FIG. 5 illustrates a cross-sectional view of the base portion at the same position shown in FIG. 4, where the plug signal terminals are not shown;

FIG. 6A illustrates a perspective view of the plug connector according to some embodiments of the instant disclosure;

FIG. 6B illustrates an enlarged partial view of the region 6B shown in FIG. 6A;

FIG. 7 illustrates a side view of a plug member according to some embodiments of the instant disclosure;

FIG. 8A illustrates a cross-sectional view along line 8A-8A shown in FIG. 1A, showing the arrangement among the plug member, the plug signal terminals, the plug power terminals, and the base portion;

FIG. 8B illustrates an enlarged partial view of the region 8B shown in FIG. 8A;

FIG. 9 illustrates an exploded view of a receptacle connector according to some embodiments of the instant disclosure;

FIG. 10 illustrates a top view of the receptacle connector according to some embodiments of the instant disclosure;

FIG. 11 illustrates a cross-sectional view along line 11-11 shown in FIG. 10;

FIG. 12 illustrates a top view of a receptacle connector according to some other embodiments of the instant disclosure;

FIG. 13 illustrates a perspective view of a receptacle signal terminal according to some embodiments of the instant disclosure;

FIG. 14A illustrates a perspective view of a receptacle power terminal according to a first embodiment of the instant disclosure;

FIG. 14B illustrates a perspective view of a receptacle power terminal according to a second embodiment of the instant disclosure;

FIG. 14C illustrates a perspective view of a receptacle power terminal according to a third embodiment of the instant disclosure;

FIG. 14D illustrates a perspective view of a receptacle power terminal according to a fourth embodiment of the instant disclosure;

FIG. 14E illustrates a perspective view of a receptacle power terminal according to a fifth embodiment of the instant disclosure;

FIG. 15A illustrates an enlarged partial view of the region 14A shown in FIG. 14A;

FIG. 15B illustrates an enlarged partial view of the region 14B shown in FIG. 14B; and

FIG. 16 illustrates a cross-sectional view of the floating-type board-to-board connector assembly according to some embodiments of the instant disclosure, where the plug connector and the receptacle connector are respectively arranged on two circuit boards and are electrically connected to each other, and the circuit boards are illustrated by dashed lines.

### DETAILED DESCRIPTION

In the embodiments provided below, terms regarding “width” may be the average width or the width of a certain portion. Terms regarding “connection”, otherwise specified as electrical connection, may be physical connection or may be direct or indirect connection between physical members. Moreover, the drawings are provided merely for illustrative purposes and not drawn to the scale, and it is realized that the drawings are not illustrated to show all the details of the components. Moreover, the term “a/an”, “two”, “upper”, “lower” are merely provided for allowing the reader to understand the description hereinafter, and are not used to limit the scope of the instant disclosure; changes or adjustments in the relationship between two components, without substantial changes in the technical content, shall also be considered within the scope of the instant disclosure.

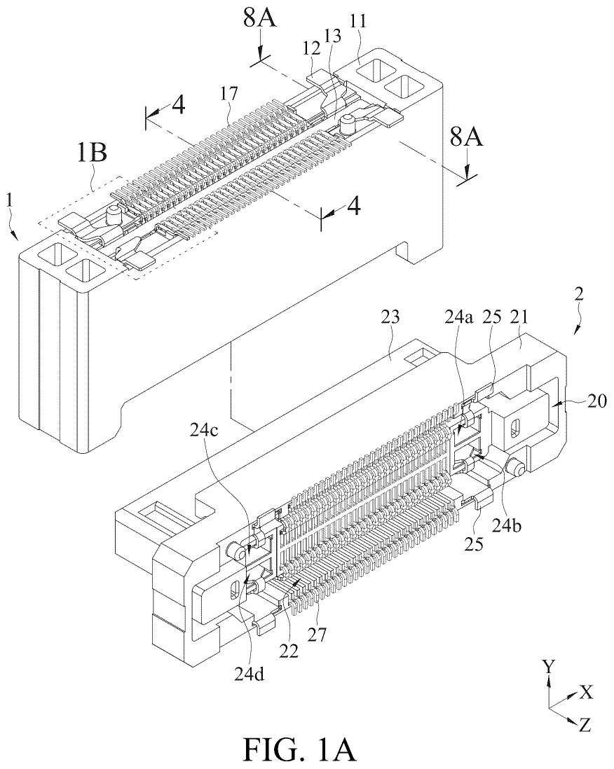

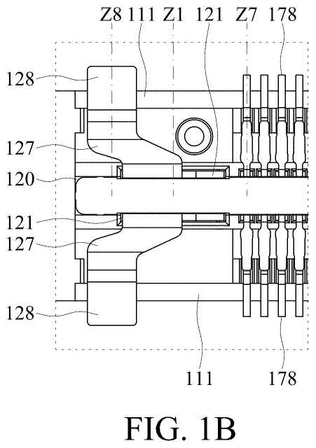

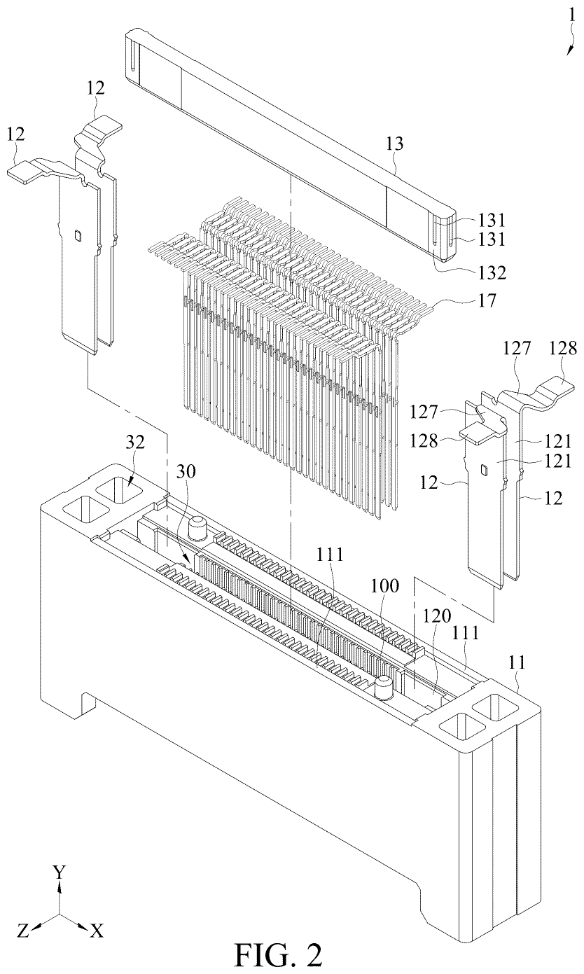

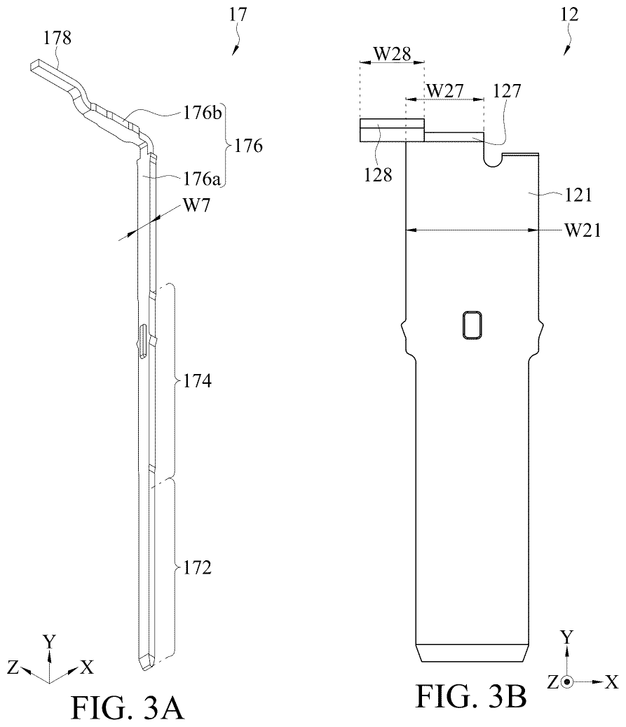

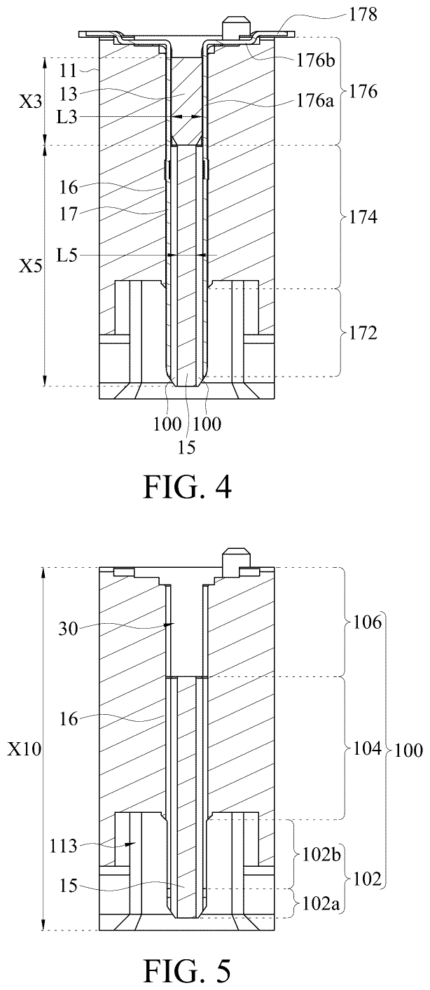

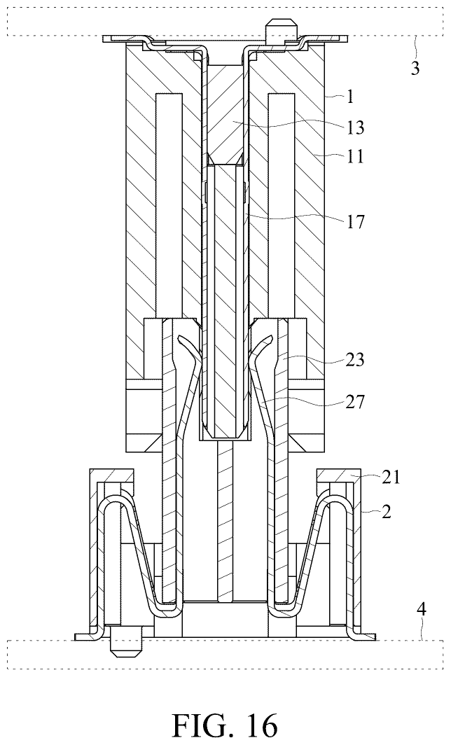

Please refer to FIG. 1A, FIG. 1B, FIG. 2, FIG. 3A, FIG. 3B, FIG. 4, FIG. 5, and FIG. 16. FIG. 1A illustrates an exploded view of a floating-type board-to-board connector assembly according to some embodiments of the instant disclosure; FIG. 1B illustrates an enlarged partial view of the region 1B shown in FIG. 1A; FIG. 2 illustrates an exploded view of a plug connector 1 according to some embodiments of the instant disclosure; FIG. 3A illustrates a perspective view of a plug signal terminal 17 according to some embodiments of the instant disclosure; FIG. 3B illustrates a perspective view of a plug power terminal 12 according to some embodiments of the instant disclosure; FIG. 4 illustrates a cross-sectional view along line 4-4 shown in FIG. 1A; FIG. 5 illustrates a cross-sectional view along line 4-4 shown in FIG. 1A, where the base portion 11 is shown while the plug signal terminals 17 are not shown; and FIG. 16 illustrates a cross-sectional view of the floating-type board-to-board connector assembly according to some embodiments of the instant disclosure, where the plug connector 1 and the receptacle connector 2 are respectively arranged on two circuit boards 3, 4 and are electrically connected to each other, and the circuit boards 3, 4 are illustrated by dashed lines.

Please refer to FIG. 1A. A floating-type board-to-board connector assembly comprises a plug connector 1 and a receptacle connector 2. The floating-type board-to-board connector assembly is adapted to be installed in the advanced driver assistance (ADAS) of a vehicle-mounted apparatus (such as an audiovisual apparatus or an autopilot apparatus). Please refer to FIG. 16. The plug connector 1 is adapted to be assembled on a surface of a circuit board 3, and the plug connector 1 is adapted to be electrically connected to the receptacle connector 2 which is assembled on another circuit board 4. Hereinafter, some embodiments are provided to describe the detail structures of the plug connector 1, and some other embodiments are then provided to describe the detail structures of the receptacle connector 2. For clarity, in the following embodiments, in the case that the plug connector 1 arranged on the circuit board 3 is mated with the receptacle connector 2 arranged on the circuit board 4 (as shown in FIG. 16), the side where the circuit board 3 is located is referred to as the upper side or the top side, while the opposite side (the side where the circuit board 4 is located) is referred to as the lower side or the bottom side.

Please refer to FIG. 2. The plug connector 1 comprises a base portion 11, a plug member 13, and a plurality of plug signal terminals 17. Please refer to FIG. 4 and FIG. 5. The base portion 11 comprises two inner walls 16, a tongue portion 15, a recessed portion 30, and a plurality of signal terminal grooves 100. The inner walls 16 are inner side surfaces extending downward from the top surface of the base portion 11. The tongue portion 15 is between the two inner walls 16, one of two ends of the tongue portion 15 is not flush with the top surface of the base portion 11, and the other end of the tongue portion 15 extends downward and is not flush with the inner walls 16 along the length direction of the base portion 11. The recessed portion 30 is enclosed by the one end of the tongue portion 15 and the two inner walls 16, and the recessed portion 30 is the space recessed toward the tongue portion 15 from the top surface of the base portion 11. The signal terminal grooves 100 are at two sides of the tongue portion and at the inner walls 16, and each of the plug signal terminals 17 is in a corresponding one of the signal terminal grooves 100 (as shown in FIG. 4). Please refer to FIG. 3A. Each of the plug signal terminals 17 comprises a flat contact section 172, a fixed section 174, an extension section 176, and a soldering section 178. The fixed section 174 is in the signal terminal groove 100 and engaged with the inner walls 16. The flat contact section 172 extends from one of two ends of the fixed section 174 and is exposed from one of two sides of the tongue portion 15, the extension section 176 extends from the other end of the fixed section 174 and is exposed from one of two sides of the recessed portion 30, and the extension section 176 curvedly extends toward the soldering section 178 along the inner walls 16 and the top surface of the base portion 11. That is, in this embodiment, the soldering section 178 is at a top end of the plug signal terminal 17, while the flat contact section 172 is at a bottom end of the plug signal terminal 17. Moreover, the plug member 13 is arranged in the recessed portion 30, and two sides of the plug member 13 contact the extension section 176 of the plug signal terminal 17. Please refer to FIG. 4. A longitudinal portion 176a of the extension section 176 is between the plug member 13 and the inner walls 16, and a radial portion 176b of the extension section 176 is on the top surface of the base portion 11. The soldering section 178 extends from one end of the extension section 176 and is exposed from the base portion 11. In some embodiments, the plug member 13 may be made of plastic. Therefore, the plug member 13 can be provided for limiting the movements of the terminals. Moreover, because it is realized that the difference between the dielectric constant of air and the dielectric constant of the base portion 11 affects the high-frequency signal transmission performance of the connector, the plug member 13 can also reduce the exposure of the terminals to air to maintain the high-frequency signal transmission performance. Furthermore, during the molding process of the base portion 11, if the inserted length of the mold core is too long (for example, greater than 7 mm), the mold core may be bent easily; however, through the configuration of the recessed portion 30 of the plug connector 1, the difficulty in the manufacturing of the base portion 11 can be reduced.

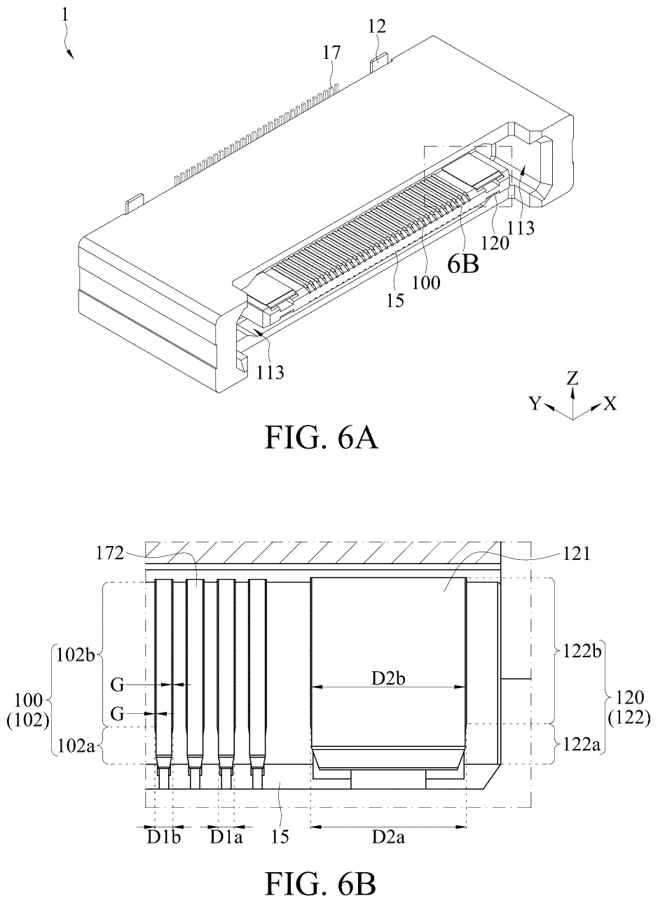

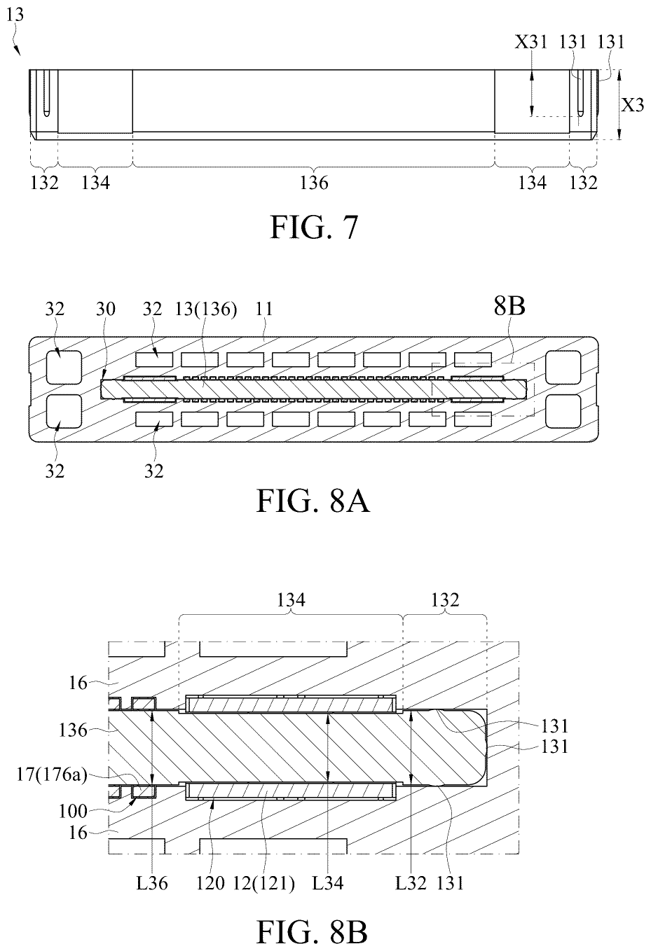

Please refer to FIG. 6A, FIG. 6B, FIG. 7, FIG. 8A, and FIG. 8B. FIG. 6A illustrates a perspective view of the plug connector 1 according to some embodiments of the instant disclosure; FIG. 6B illustrates an enlarged partial view of the region 6B shown in FIG. 6A; FIG. 7 illustrates a side view of a plug member 13 according to some embodiments of the instant disclosure; FIG. 8A illustrates a cross-sectional view along line 8A-8A shown in FIG. 1A; FIG. 8B illustrates an enlarged partial view of the region 8B shown in FIG. 8A.

Please refer to FIG. 5. In some embodiments, the tongue portion 15 extends toward the bottom portion of the base portion 11 from one-third the height of the inner walls 16 and is exposed from the base portion 11. Each of the signal terminal grooves 100 comprises an exposed section 102, a channel section 104, and a communication section 106. Two ends of the channel section 104 are respectively in communication with the exposed section 102 and the communication section 106, the exposed section 102 is at the bottom portion of the base portion 11, the communication section 106 is at the top portion of the base portion 11, and the communication sections 106 of two adjacent or opposite signal terminal grooves 100 are in communication with each other to form the recessed portion 30. Please refer to FIG. 4. The flat contact section 172 of the plug signal terminal 17 is at the exposed section 102, the fixed section 174 is at the channel section 104, and the extension section 176 is at the communication section 106, where the flat contact section 172 is interference-fitted with the exposed section 102.

Please refer to FIG. 6A and FIG. 6B. The exposed section 102 of the signal terminal groove 100 comprises a tapered portion 102a and an accommodation portion 102b, where a distance D1a between two side walls of the tapered portion 102a is less than a distance D1b between two side walls of the accommodation portion 102b. Specifically, in this embodiment, the free end of the flat contact section 172 is closely attached on the two side walls of the tapered portion 102a, while a gap G is between each of the two side walls of the accommodation portion 102b and the flat contact section 172. That is, in this embodiment, a width of the flat contact section 172 is substantially equal to the distance D1a but is less than the distance D1b; the free end of the flat contact section 172 is interference-fitted with the two side walls of the signal terminal groove 100 (the tapered portion 102a), and the plug signal terminal 17 has an “anti-warpage” configuration. Accordingly, during the mating process between the plug connector 1 and the receptacle connector 2, malfunction risk due to damage of the terminal can be reduced.

Please refer to FIG. 6A. In some embodiments, the bottom portion of the base portion 11 has a guiding groove 113; the tongue portion 15 outward protrudes from the guiding groove 113, the exposed section 102 is exposed from the guiding groove 113, and two ends of the guiding groove 113 have chamfered structures. The guiding groove 113 is adapted to be mated with the floating base 23 of the receptacle connector 2, and the guiding groove 113 provides a space for accommodating the receptacle connector 2 when the plug connector 1 is mated with the receptacle connector 2.

Please refer to FIG. 8A. In some embodiments, the base portion 11 has a plurality of material escaping grooves 32. The material escaping grooves 32 are provided for adjusting the thickness of the base portion 11, and the material escaping grooves 32 are symmetrically arranged at two sides of the base portion 11 with respect to a center of the base portion 11. Take the embodiment shown in FIG. 8A as an example, four material escaping grooves 32 are respectively arranged at diagonal positions of the base portion 11. Therefore, during the molding process of the base portion 11, the thickness over the base portion 11 can be configured evenly to reduce incomplete and insufficient mold issues.

Moreover, as shown in FIG. 2, in some embodiments, the plug connector 1 does not have the plug power terminals 12. In some embodiments, the plug connector 1 further comprises a plurality of plug power terminals 12, and the base portion 11 further comprises a plurality of power terminal grooves 120; each of the plug power terminals 12 corresponds to a corresponding one of the power terminal grooves 120, the power terminal grooves 120 are at two sides of the tongue portion 15 and at the inner walls 16, and the plug power terminals 12 are arranged in the power terminal grooves 120. The signal terminal grooves 100 are at a middle portion of the base portion 11, and the power terminal grooves 120 are adjacent to two ends of the base portion 11. The plug power terminal 12 comprises a plate section 121, a curved section 127, and a soldering section 128, the curved section 127 is between the plate section 121 and the soldering section 128, the plate section 121 is in the power terminal groove 120, the curved section 127 is at the top surface of the base portion 11, and the soldering section 128 is exposed from the base portion 11.

Please refer to FIG. 3A and FIG. 3B. A width of the plug power terminal 12 is greater than a width of the plug signal terminal 17. In some embodiments, an average width of the narrowest portion (for example, the soldering section 128) of the plug power terminal 12 is greater than an average width of the widest portion (for example, a width W7 of the longitudinal portion 176a shown in FIG. 3A) of the plug signal terminal 17. In some embodiments, a width W27 of the curved section 127 of the plug power terminal 12 is greater than the width of the plug signal terminal 17 or greater than the width W7 of the extension section 176 (the longitudinal portion 176a) of the plug signal terminal 17. In some embodiments, as shown in FIG. 3B, a width W21 of the plate section 121 of the plug power terminal 12 is greater than the width W27 of the curved section 127, the width W27 of the curved section 127 is greater than a width W28 of the soldering section 128, and the width W27 of the curved section 127 is gradually reduced from the plate section 121 toward the soldering section 128. In some embodiments, the current capacity of the plug power terminal 12 is 3A, the current capacity of the plug signal terminal 17 is 0.5A, and the width W27 of the curved section 127 of the plug power terminal 12 is in a range between 0.5 and 0.7 times the width W21 of the plate section 121. Accordingly, the width W27 of the curved section 127 of the plug power terminal 12 can be increased, so that not only the large current transmission function can be retained but also the heat dissipation performance of the plug connector 1 can be enhanced.

Moreover, please refer to FIG. 1B and FIG. 2. In some embodiments, the base portion 11 has a flange 111, the flange 111 outward protrudes from the top surface of the base portion 11, the plate section 121 of the plug power terminal 12 is in the power terminal groove 120, and the curved section 127 eccentrically extends toward the flange 111 from an opening of the power terminal groove 120. The term “eccentrically” indicates that the component is deflected from the symmetrical center, and the symmetrical center may be the symmetrical center of the plug power terminal 12, the symmetrical center of the plate section 121 of the plug power terminal 12, the symmetrical center of the opening of the power terminal groove 120, or the symmetrical center of the base 11. The soldering section 128 leans against the flange 111 and extends radially and outward. Please refer to FIG. 3B, a height step is formed between two ends of the curved section 127.

Please refer to FIG. 1B. In some embodiments, the curved section 127 of the plug power terminal 12 is tapered from the plate section 121 toward the soldering section 128, and the soldering section 128 and the plate section 121 extend eccentrically. Please refer to FIG. 1B, the curved section 127 curvedly extends toward the soldering section 128 from the plate section 121 along a direction away from the plug signal terminal 17 (the soldering section 178) (for example, along the direction from right to left shown in FIG. 1B). In other words, in this embodiment, a radial central line Z8 of the soldering section 128 is at one side of a radial central line Z1 of the plate section 121, and the two radial central lines are not aligned. A distance between the plate section 121 of the plug power terminal 12 and the plug signal terminal 17 is less than a distance between the soldering section 128 of the plug power terminal 12 and the plug signal terminal 17. In other words, in this embodiment, a distance between the radial central line Z1 and a radial central line Z7 of the plug signal terminal 17 is less than a distance between the radial central line Z8 and the radial central line of the plug signal terminal 17. Accordingly, the distance between the soldering section 128 of the plug power terminal 12 and the plug signal terminal 17 can be increased to enhance the heat dissipation function of the plug connector 1.

Please refer to FIG. 6B. In some embodiments, the power terminal groove 120 comprises an exposed section 122, and the exposed section 122 is at the bottom portion of the base portion 11. The exposed section 122 comprises a tapered portion 122a and an accommodation portion 122b, where a distance D2a between two side walls of the tapered portion 122a is less than a distance D2b between two side walls of the accommodation portion 122b. Specifically, in this embodiment, a portion of the plate section 121 of the plug power terminal 12 is in the exposed section 122 of the power terminal groove 120, the free end of the plate section 121 is closely attached on the two side walls of the tapered portion 122a, and a gap is between each of the two side walls of the accommodation portion 112b and the plate section 121. That is, in this embodiment, the width of the free end of the plate section 121 is substantially equal to the distance D2a but is less than the distance D2b; the free end of the plate section 172 is interference-fitted with the two side walls of the power terminal groove 120 (the tapered portion 122a), so that the plug signal terminal 17 has an “anti-warpage” configuration.

Please refer to FIG. 4 and FIG. 5. In some embodiments, the ratio between a height X3 of the plug member 13 and a height X10 of the base portion 10 is about 1:3, the ratio between the height X3 of the plug member 13 and a height X5 of the tongue portion 15 is about 1:2, and a thickness L3 of the plug member 13 is greater than a thickness L5 of the tongue portion 15, so that movements of the terminals can be properly limited. Take the viewing angle of FIG. 4 as an example, the height is the vertical distance between the top surface and the bottom surface of the component, and the thickness is the horizontal distance between two opposite side surfaces of the component. Specifically, as shown in FIG. 7, the plug member 13 comprises two end portions 132, a first contact section 136, two second contact sections 134, and a plurality of ribs 131. Each of two ends of the first contact section 136 sequentially extends toward the second contact sections 134 and the end portions 132, where the ribs 131 are at the end portions 132, the ribs 131 extend downward from the top portion of the plug member 13, a height X31 of each of the ribs 131 is less than the height X3 of the plug member 13, and the height X31 is the vertical distance between the bottom portion 131 of the rib 131 and the top surface of the plug member 13. Please refer to FIG. 8B. A position of the first contact section 136 corresponds to a position of the plug signal terminal 17 (or the signal terminal groove 100 of the base portion 11), and a position of the second contact section 134 corresponds to a position of the plug power terminal 12 (or the power terminal groove 120 of the base portion 11). The ribs 131 are interference-fitted with the two inner walls 16 of the base portion 11, two sides of the first contact section 136 of the plug member 13 contact the extension section 176 (the longitudinal portion 176a) of the plug signal terminal 17, the second contact section 134 of the plug member 13 contacts the plate section 121 of the plug power terminal 12, a thickness L34 of the second contact section 134 is less than a thickness L36 of the first contact section 136, and the thickness L36 of the first contact section 136 is less than a thickness L32 of the end portion 132.

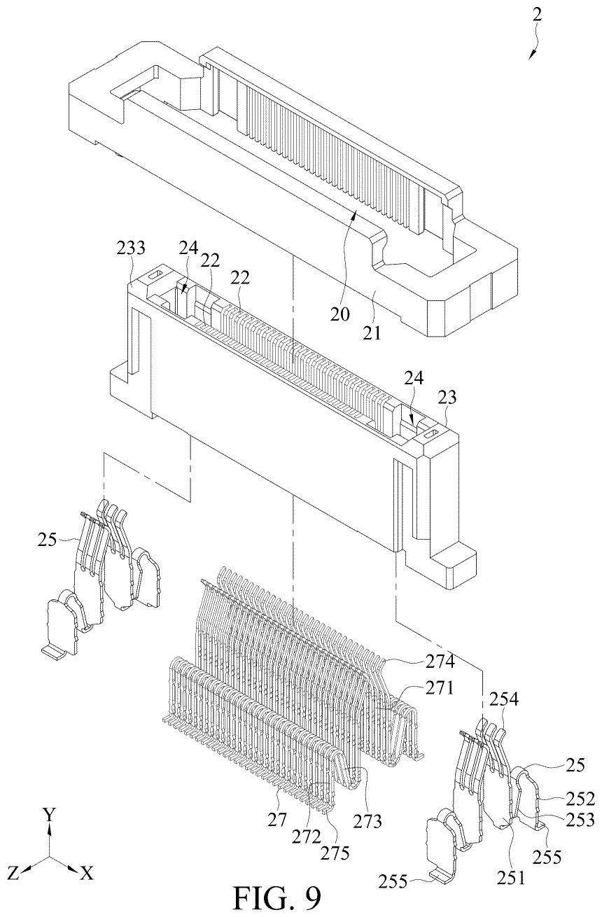

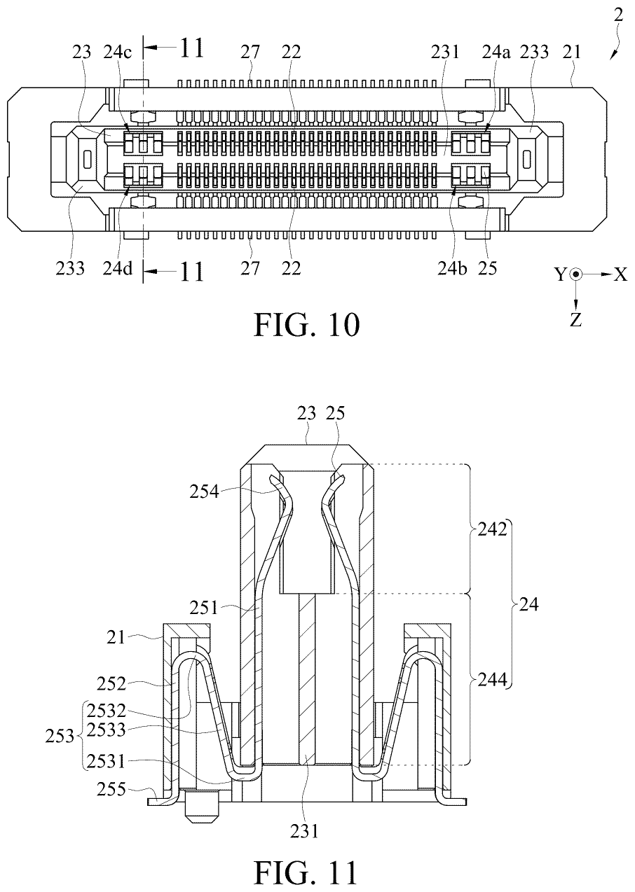

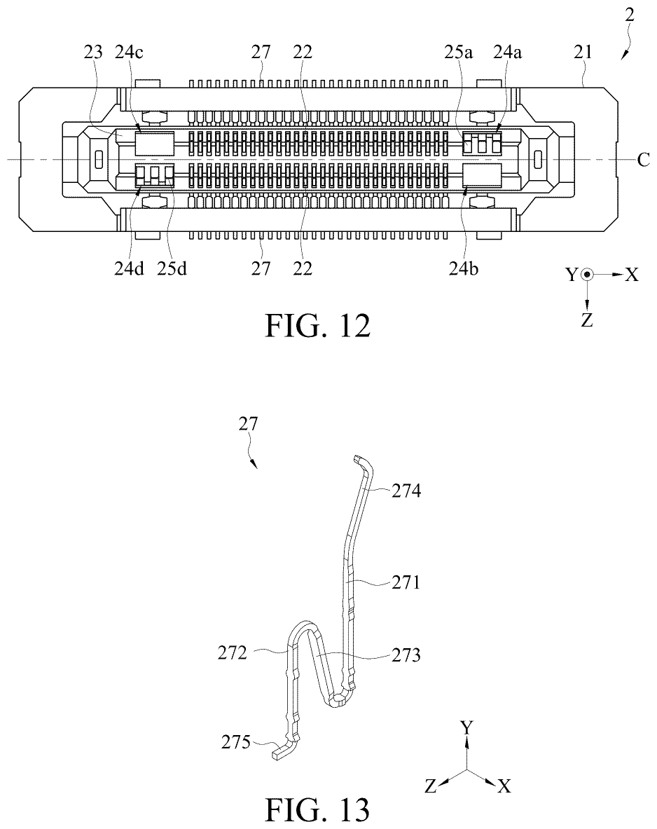

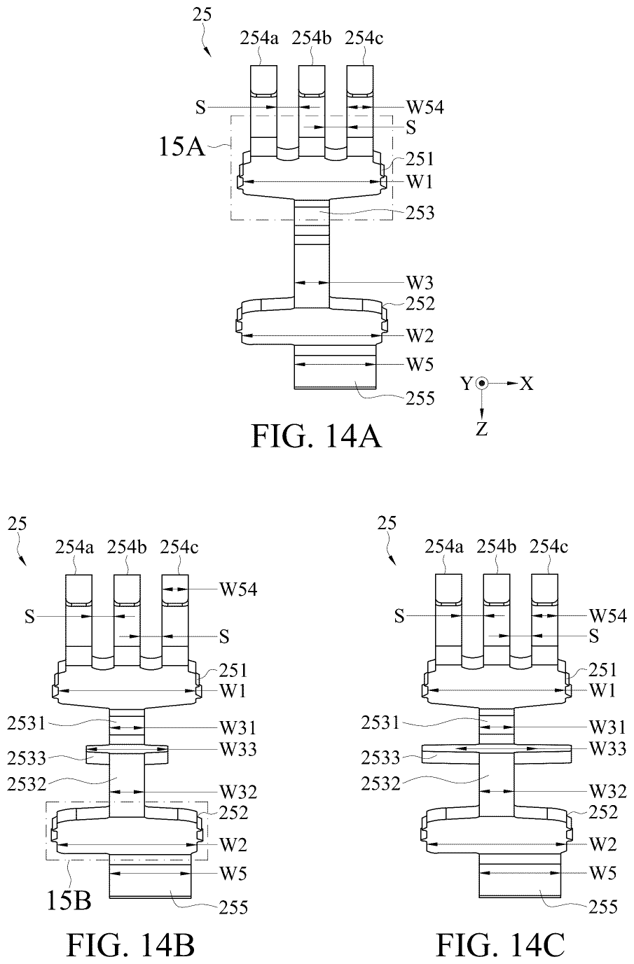

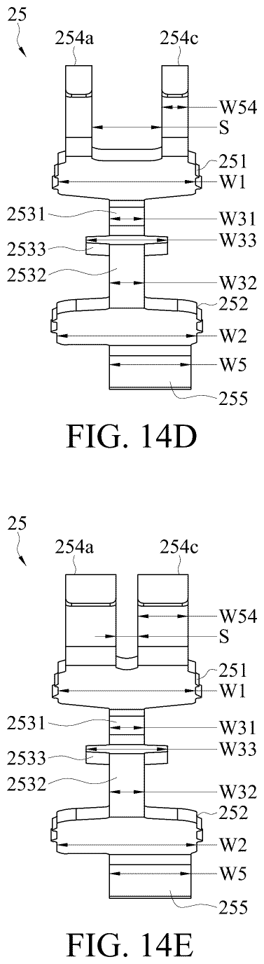

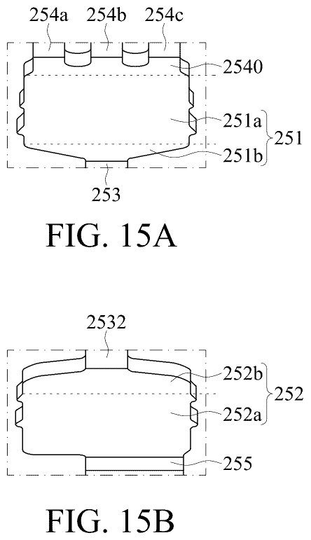

On the other hand, please refer to FIG. 9, FIG. 10, FIG. 11, FIG. 12, FIG. 13, FIG. 14A, FIG. 14B, and FIG. 15B. FIG. 9 illustrates an exploded view of a receptacle connector 2 according to some embodiments of the instant disclosure; FIG. 10 illustrates a top view of the receptacle connector 2 according to some embodiments of the instant disclosure; FIG. 11 illustrates a cross-sectional view along line 11-11 shown in FIG. 10; FIG. 12 illustrates a top view of a receptacle connector 2 according to some other embodiments of the instant disclosure; FIG. 13 illustrates a perspective view of a receptacle signal terminal 27 according to some embodiments of the instant disclosure; FIG. 14A illustrates a perspective view of a receptacle power terminal 25 according to a first embodiment of the instant disclosure; FIG. 14B illustrates a perspective view of a receptacle power terminal 25 according to a second embodiment of the instant disclosure; and FIG. 15B illustrates an enlarged partial view of the region 14B shown in FIG. 14B.

Please refer to FIG. 9. The receptacle connector 2 comprises a fixed base 21, a floating base 23, a plurality of receptacle signal terminals 27, and a plurality of receptacle power terminals 25. The fixed base 21 has a through groove 20, the floating base 23 is in the through groove 20, and the floating base 23 has a plurality of signal terminal grooves 22 and a plurality of power terminal grooves 24. The power terminal grooves 24 are at two ends of the floating base 23, and the signal terminal grooves 22 are at a middle portion of the floating base 23. In some embodiments, the top portion of the floating base 23 has two guiding end portions 233, the guiding end portions 233 outward protrude from the two ends of the top surface of the floating base 23, and the guiding end portions 233 have chamfered structures. In some embodiments, a misalignment tolerance between the plug connector 1 and the receptacle connector 2 may be up to 1.30 mm. Therefore, upon the plug connector 1 is mating with the receptacle connector 2,—the guiding capability and the misalignment tolerance between the connectors of the product can be enhanced.

Please refer to FIG. 9. The receptacle power terminals 25 are arranged in the power terminal grooves 24, and the receptacle signal terminals 27 are arranged in the signal terminal grooves 22. Two ends of the receptacle signal terminal 27 are respectively connected to the fixed base 21 and the floating base 23, and two ends of the receptacle power terminal 25 are respectively connected to the fixed base 21 and the floating base 23. That is, in this embodiment, the fixed base 21 and the floating base 23 are indirectly connected to each other through the receptacle plug terminals 27 and the receptacle power terminals 25, and the fixed base 21 and the floating base 23 do not contact each other. Please refer to FIG. 16. In some embodiments, the movement tolerance (or referred to as the floating amount) of the floating base 23 along the X axis or the Z axis is about ±0.8 mm, and the movement tolerance of the floating base 23 along the Y axis is about ±0.5 mm. Therefore, the plug connector 1 and the receptacle connector 2 are mated with each other in a floating manner, and the floating base 23 of the receptacle connector 2 has movement tolerances along multiple axes in the through groove 20 of the fixed base 21, so that the external force suffered during shaking can be absorbed. Moreover, such configuration ensures the stability of the floating base 23 and allows the electrical connection between the receptacle connector 1 and the plug connector 2 to be maintained properly.

Please refer to FIG. 9 and FIG. 13. Each of the receptacle signal terminals 27 comprises a contact section 274, a first fixed section 271, a second fixed section 272, a connection section 273, and a soldering section 275. The first fixed section 271 is engaged with the inner walls of the floating base 23, the second fixed section 272 is engaged with the fixed base 21, the contact section 274 extends toward an interior of the floating base 23 from one of two ends of the first fixed section 271, the connection section 273 extends toward the second fixed section 272 from the other end of the fixed section 271, and the soldering section 275 extends from one end of the second fixed section 272 and is exposed from the fixed base 21. In some embodiments, the connection section 273 is the widest portion of the receptacle signal terminal 27; that is, in some embodiments, a width of the connection section 273 is greater than any of a width of the contact section 274, a width of the first fixed section 271, a width of the second fixed section 272, or a width of the soldering section 275. In some embodiments, the structure of the receptacle signal terminal 27 in the signal terminal groove 22 is the same as the structure shown in FIG. 11, and details are provided in the following embodiments.

In the following paragraphs, the structure details of the receptacle power terminal 25 are described.

Please refer to FIG. 11. The power terminal grooves 24 are at the inner side surface of the floating base 23, and the power terminal groove 24 comprises a mating section 242 and an engaging section 244. The mating sections 242 of two opposite power terminal grooves 24 are in communication with each other, so that a mating space can be provided by the receptacle connector 2 for being mated with the plug connector 1. A partition wall 231 of the floating base 23 separates the engaging sections 244 of the two opposite power terminal grooves 24 from each other.

Each of the receptacle power terminals 25 comprises a contact section 254, a first fixed section 251, a second fixed section 252, a connection section 253, and a soldering section 255. The contact section 254 is in the mating section 242 of the power terminal groove 24, and the contact section 254 is adapted to contact the plate section 121 of the plug power terminal 12 of the plug connector 1. The first fixed section 251 of the receptacle power terminal is engaged with the inner walls of the floating base 23 (the engaged section 244 of the power terminal groove 24), the second fixed section 252 is engaged with the fixed base 21, and the contact section 254 extends toward the interior of the floating base 23 from one of two ends of the first fixed section 271. As shown in FIG. 11 and FIG. 14A, the connection section 253 extends toward the second fixed section 252 from the other end of the fixed section 251, and the soldering section 255 is exposed from the fixed base 21. The narrowest portion of the receptacle power terminal 25 is the connection portion 253. Specifically, in some embodiments, the connection section 253 comprises a first bent portion 2531, an inclined portion 2533, and a second bent portion 2532. The inclined portion 2533 is between the floating base 23 and the fixed base 21, the first bent portion 2531 is at the bottom surface of the floating base 23, and the second bent portion 2532 is at the inner surface of the fixed base 21. The first bent portion 2531 extends toward the inclined portion 2533 from the other end of the first fixed section 251, and two ends of the second bent portion 2532 respectively extend toward the inclined portion 2533 and the second fixed section 252. Please refer to FIG. 14B and FIG. 15B. The second fixed section 252 is configured as a continuous plate structure and does not have cut grooves. The second fixed section 252 comprises a first plate portion 252b and a second plate portion 252a, the first plate portion 252b extends toward the second bent portion 2532, and the second plate portion 252a extends toward the soldering section 255, where a width W32 of the second bent portion 2532 is less than a width W2 of the second fixed section 252. In some embodiments, two opposite sides of the second plate portion 252a are provided with flanges to be engaged with the fixed base 21. Two opposite sides of the first plate portion 252b taper toward a central portion where it is connected to the second bent portion 2532, and extend toward the soldering section 255.

Take the embodiment shown in FIG. 14A as an example, the first fixed section 251, the connection section 253, and the second fixed section 252 are together configured as an continuous plate structure, and none of the first fixed section 251, the connection section 253, and the second fixed section 252 has cut grooves. The average width of a width W31 of the first bent portion 2531, a width W33 of the inclined portion 2533, and the width W32 of the second bent portion 2532 is a width W3 of the connection section 253, and the width W3 is less than the width W1 of the first fixed section 251 or less than the width W2 of the second fixed section 252. Accordingly, the bent structure (such as the connection section 253) of the receptacle power terminal 25 has a tapered configuration. Therefore, the receptacle power terminal 25 with large current capacity can provide proper flexibility, and the position offset caused by external forces can be properly addressed. Moreover, because both the areas of the first fixed section 251 and the second fixed section 252 increase, heat dissipation and conduction performances of the terminal can be enhanced to achieve large current transmission.

As shown in FIG. 10, in some embodiments, the receptacle connector 2 has four receptacle power terminals 25, and the four receptacle power terminals 25 are symmetrically arranged in the four power terminal grooves 24a, 24b, 24c, 24d. For example, the power terminal grooves 24a, 24b are at one of two ends of the floating base 23, the power terminal grooves 24c, 24d are at the other end of the floating base 23, and the four power terminal grooves 24a, 24b, 24c, 24d are respectively at four diagonal positions of the floating base 23, as shown in FIG. 10. As shown in FIG. 12, in some embodiments, the receptacle connector 2 has two receptacle terminals 25a, 25d, and the two receptacle terminals 25a, 25d are symmetrically arranged in the power terminal grooves 24a, 24d. For example, the receptacle power terminals 25a, 25d are respectively arranged in the power terminal grooves 24a, 24d which are at opposite ends of the floating base 23, the receptacle power terminals 25a, 25d are at diagonal positions of the floating base 23, the receptacle power terminals 25a, 25d are respectively at opposite sides with respect to a central axis C of the floating base 23, and a vertical distance between the receptacle power terminal 25a and the central axis C is equal to a vertical distance between the receptacle power terminal 25d and the central axis C, as shown in FIG. 12.

Please refer to FIG. 14C, FIG. 14D, FIG. 14E, and FIG. 15A. FIG. 14C illustrates a perspective view of a receptacle power terminal 25 according to a third embodiment of the instant disclosure; FIG. 14D illustrates a perspective view of a receptacle power terminal 25 according to a fourth embodiment of the instant disclosure; FIG. 14E illustrates a perspective view of a receptacle power terminal 25 according to a fifth embodiment of the instant disclosure; and FIG. 15A illustrates an enlarged partial view of the region 14A shown in FIG. 14A.

Please refer to FIG. 14A and FIG. 14D. In some embodiments, the contact section 254 comprises a plurality contact free ends, and the contact section 254 may comprise three contact free ends 254a, 254b, 254c (as shown in FIG. 14A) or may comprise two contact free ends 254a, 254c (as shown in FIG. 14D). Please refer to FIG. 14A. In some embodiments, the contact free ends 254a, 254b, 254c are parallel to each other, and a pitch S is between each two adjacent contact free ends 254a, 254b, 254c. In other words, in some embodiments, the contact section 254 of the receptacle power terminal 25 has a cut groove. A width W54 of each of the contact free ends 254a, 254b, 254c is less than the width W3 of the connection section 253. In some embodiments, the width W3 of the connection section 253 is 0.6 mm, and the width W54 of each of the contact free ends 254a, 254b, 254c is about in a range between 0.4 mm and 0.45 mm. Accordingly, the receptacle power terminals 25 of the receptacle connector 2 are mated with the plug power terminals 12 of the plug connector 1 in a multi-point contact manner, thereby enhancing the terminal flexibility while maintaining the maximum current capacity of the terminal (or referred to as current transmission ability). Moreover, in order to minimize the connector, a terminal configuration which not only can enhance the current transmission ability but also perform proper flexibility is provided, allowing the application scenarios for the connector to be more flexible, convenient, and reliable.

Please refer to FIG. 14A and FIG. 15A. In some embodiments, the contact section 254 has three contact free ends 254a, 254b, 254c, and the connection portion among the three contact free ends 254a, 254b, 254c is a base portion 2540 of the contact section 254. A width of the base portion 2540 is substantially equal to the width W1 of the first fixed section 251. The first fixed section 251 has an engaged portion 251a and a tapered portion 251b, the engaged portion 251a extends toward the base portion 2540 of the contact section 254, and the tapered portion 251b extends toward the connection section 253. In some embodiments, two opposite sides of the engaged portion 251a are provided with flanges to be engaged with the inner walls of the floating base 23. Two opposite sides of the tapered portion 251b taper toward a central portion where it is connected to the connection section 253, and extend toward the connection section 253.

In the following paragraphs, the structure details of the connection section 253 of the receptacle power terminal 25 are described.

Please refer to FIG. 14A. In some embodiments, the width W1 of the first fixed section 251 is equal to the width W2 of the second fixed section 252. A width W5 of the soldering section 255 is greater than the width W3 of the connection section 253 but is less than the width W1. The width of the first bent portion 2531, the width of the inclined portion 2533, and the width of the second bent portion 2532 are all the same. Moreover, the width W3 of the connection section 253 is greater than or equal to a width of the receptacle signal terminal 27.

Please refer to FIG. 14B. In some embodiments, both the width W31 of the first bent portion 2531 and the width W32 of the second bent portion 2532 of the connection section 253 are less than the width W33 of the inclined portion 2533. That is, in some embodiments, the first bent portion 2531 and the second bent portion 2532 are narrower portions of the connection section 253. The width W31 is equal to the width W32, and the width W33 is less than the width W1 and greater than the width W31. Moreover, the contact section 254 has three contact free ends 254a, 254b, 254c, a width W54 of each of the contact free ends 254a, 254b, 254c is less than the width W31 and less than the width W32. In some embodiments, the ratio between the width W54 and the width W31 is 2:3.

Please refer to FIG. 14C. In some embodiments, the width W1 of the first fixed section 251, the width W2 of the second fixed section 252, and the width W33 of the inclined portion 2533 are the same, the width W31 of the first bent portion 2531 and the width W32 of the second 2532 may be the same or different from each other, and both the width W31 and the width W32 are greater than the width of the receptacle signal terminal 27.

Please refer to FIG. 14D. In some embodiments, the contact section 254 has two contact free ends 254a, 254c, the width W33 of the inclined portion 2533 is greater than the pitch S between the contact free ends 254a, 254c, the pitch S is greater than the width W4 of each of the contact free ends 254a, 254c, both the width W31 of the first bent portion 2531 and the width W32 of the second bent portion 2532 are greater than the width W54, and both the width W31 and the width W32 is less than the pitch S. In some embodiments, the summation of the pitch S and the width W54 of each of the contact free ends 254a, 254c is the width of the base portion 2540 of the contact section 254, and the width of the base portion 2540 is substantially equal to the width W1 of the first fixed section 251.

Please refer to FIG. 14E. In some embodiments, the contact section 254 has two contact free ends 254a, 254c, both the width W31 of the first bent portion 2531 and the width W32 of the second bent portion 2532 are less than the width W54 of each of the contact free ends 254a, 254c, the width W31 of the first bent portion 2531 is greater than the pitch S between the contact free ends 254a, 254c, and the pitch S is less than the width W54.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A board-to-board plug connector comprising:
a base portion comprising two inner walls, a tongue portion, a recessed portion, and a plurality of signal terminal grooves, wherein the tongue portion is between the two inner walls, the signal terminal grooves are at two sides of the tongue portion and at the two inner walls, and the recessed portion is enclosed by one end of the tongue portion and the two inner walls;
a plurality of plug signal terminals, wherein each of the plug signal terminals comprises a fixed section in a corresponding one of the signal terminal grooves, a flat contact section extending from one of two ends of the fixed section and exposed from one of the two sides of the tongue portion, and an extension section extending from the other end of the fixed section and exposed from one of two sides of the recessed portion; and
a plug member arranged in the recessed portion, wherein the plug member contacts the extension sections of the plug signal terminals.

2. The board-to-board plug connector according to claim 1, wherein each of the signal terminal grooves comprises an exposed section, a channel section, and a communication section, two ends of the channel section are respectively in communication with the exposed section and the communication section, and the flat contact section is interference-fitted with the exposed section.

3. The board-to-board plug connector according to claim 2, wherein the exposed section comprises a tapered portion and an accommodation portion, a distance between two side walls of the tapered portion is less than a distance between two side walls of the accommodation portion, and a free end of the flat contact section is interference-fitted with the two side walls of the tapered portion.

4. The board-to-board plug connector according to claim 1, wherein the plug member comprises a plurality of ribs, and the ribs are interference-fitted with the two inner walls of the base portion.

5. The board-to-board plug connector according to claim 4, wherein the plug member further comprises an end portion, a first contact section, and a second contact section, one end of the first contact section extends toward the second contact section and the end portion, and the ribs are at the end portion.

6. The board-to-board plug connector according to claim 5, further comprising a plurality of plug power terminals, wherein two sides of the first contact section contact the extension section of the plug signal terminal, and the second contact section of the plug member is adapted to contact the plurality of plug power terminals.

7. The board-to-board plug connector according to claim 5, wherein a thickness of the second contact section is less than a thickness of the first contact section, and the thickness of the first contact section is less than a thickness of the end portion.

8. The board-to-board plug connector according to claim 1, wherein a ratio between a height of the plug member and a height of the base portion is 1:3.

9. The board-to-board plug connector according to claim 1, wherein a ratio between a height of the plug member and a height of the tongue portion is 1:2.

10. The board-to-board plug connector according to claim 1, wherein a thickness of the plug member is greater than a thickness of the tongue portion.
